(19) United States
(12) Patent Application Publication
(10) Pub. No.: US 2008/0245933 A1
(43) Pub. Date: Oct. 9, 2008

(54) Installation method and tool

(75) Inventor: Kevan Frederick Stokes, Portlethen (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Balmoral Group Limited

(21) Appl. No.: 12/080,345

(22) Filed: Apr. 2, 2008

(30) Foreign Application Priority Data
Apr. 4, 2007 (GB) 0706534.5

(51) Int. Cl. F16L 3/12

(52) U.S. Cl. 248/74.1

(57) ABSTRACT

The present invention relates to an installation method and a tool for installing a clamp onto a cylindrical member such as a pipeline or riser. The method comprises the steps of placing the clamp around the tubular member, applying a radial load to the clamp and subsequently securing the loaded clamp to the tubular member.

### FIELD OF THE INVENTION

This invention relates to an installation method and a tool, and more particularly to a method of installing a clamp onto a cylindrical member such as a pipeline or riser and a tool for installing a clamp thereon.

### BACKGROUND

Oil and Gas is carried from reservoirs beneath the seabed to the surface by rigid or flexible pipes known as risers. The outer diameter of a riser is subject to significant tolerances due to manufacturing specifications, tension in the riser, internal pressure, hydrostatic pressure and the temperature of the fluids which flow therein. Therefore, the outer diameter of a riser is subject to change along its length due to amongst other things, the hydrostatic pressure of the water surrounding the riser and also the temperature and pressure of the recovered fluids flowing within the riser.

Buoyancy modules are provided upon risers in order to maintain the riser in the required position for optimum use. Known buoyancy modules include C-shaped clamping members which have an internal concave surface which corresponds dimensionally to the outer surface of the riser. A plurality of such members are positioned around the riser and secured in position with a tensioned band such as a titanium strap or a band of aramid fibres such as Kevlar® or Twaron® to provide a clamp to which a buoyancy module can be secured. (Kevlar is a registered trademark of the E.I. DuPont Company for aramid fibres. Twaron is a registered trademark of. Teijin/Aramid B.V. Ltd.)

GB 2288 205 describes a band clamp for securing a buoyancy module to a flexible riser of the type commonly used in the offshore oil and gas industry. The clamp comprises a plurality of clamping members with concave, resiliently deformable inner faces which are shaped to conform to the outer surface of the riser. In use, the clamping members are placed around the outer circumference of the riser and secured in position by an elastically stretchable compression band which sits within grooves in the outer surface of the clamping members.

A tensioning bar is provided at each end of the belt and one or more bolt(s) passes between the two tensioning bars. Tightening of the bolt(s) pulls the ends of the band together thereby stretching the compression band to cause the band to exert a compressive clamping force on the clamping members and on the riser.

The radial force exerted by the clamping members on the riser is of sufficient magnitude to resist axial movement of the clamping members with respect to the riser by virtue of a friction grip. The load applied to the belt and transferred thereby to the clamping members is applied tangentially of the riser, i.e. by drawing together the two tensioning bars.

This results in an uneven load distribution around the riser. Such an imbalance in the load distribution is unavoidable as the inner face of the camp cannot rotate around the riser once tensioning of the belt has commenced and the tensioned portion of the clamp body will stretch hoop wise as it is tensioned. The clamp body will also be compressed to some extent which enhances this disproportionate loading effect.

The result of this is a shear stress within the clamp body or across an interface of the body as the outer surface of the clamp is being pulled in one direction whilst the inner surface is resisting movement in that same direction. This shear stress varies from a maximum at the tensioning point to a minimum at a point diametrically opposite. This is known as the Capstan effect and is shown diagrammatically in FIG. 1. Load that is dispersed in this way makes no contribution to the clamping force applied to the clamping members and so it is necessary to increase the applied tension to the compression band to compensate for the force losses which are attributed to this effect.

The disadvantages of increasing the applied load include that stronger components are required for the clamps as a higher force has to be exerted by the compression band, the pressure applied to the riser will be unevenly distributed around the circumference of the riser and such a stronger clamp will by necessity have to be stiffer to withstand the additional forces which reduces the capacity of the clamp to accommodate changes in the diameter of the riser.

The capstan effect can be reduced by increasing the number of tensioning points around the clamp. In some cases, four clamping points are provided which should, in theory at least, reduce the capstan effect by 75%. However, this theoretical reduction can only be achieved if all four tensioning points are equally and evenly tensioned. In practice this tends to be a very slow and unreliable process.

### SUMMARY OF THE INVENTION

The present invention aims to provide an installation tool for a clamp which overcomes or at least mitigate the above mentioned problems.

It is a further object of the present invention to provide a method of installing a clamp onto a pipeline or riser which mitigates the imbalanced loading which results from the known installation method.

According to a first aspect of the present invention there is provided a method of installing a clamp on a tubular member, the method comprising the steps of placing the clamp around the tubular member, applying a radial load to the clamp and subsequently securing the loaded clamp to the tubular member.

Preferably the clamp comprises a plurality of clamping components and the method includes the step of applying a radial load to each clamping component simultaneously.

Preferably the radial load is uniformly applied around the clamp.

Advantageously the clamping components are secured in position by a compression band which is tightened around the components.

Conveniently the clamping components are mounted in a frame to be positioned around the tubular element to ensure correct positioning thereof.

Advantageously the radial force is applied to the clamping components via a hydraulic actuator.

Preferably the radial force is applied to the clamping components via a hydraulic ram.

According to a second aspect of the present invention there is provided a tool for installing a clamp onto a tubular member, said tool comprising means for applying a radial load to the clamp before said clamp is secured to the tubular member.

Preferably, the clamp has a plurality of clamping components and the means for applying a radial load is adapted to apply the load to each clamp component simultaneously.

Preferably the means for applying a radial load is adapted to apply the load uniformly around the clamp.

Preferably the means for applying a radial load to the clamp members is a hydraulic actuator.

Preferably the hydraulic actuator is a hydraulic ram.

In one embodiment a separate hydraulic ram is provided for each clamp component.

Preferably the tool further comprises a frame upon which the radial load devices are carried.

Conveniently the frame comprises means for securing each clamping component prior to application to a tubular member.

Advantageously the frame comprises two frame members hinged together to allow the frame to be placed around a tubular member.

### BRIEF DESCRIPTION OF THE DRAWINGS

Embodiments of the present invention will now be described with reference to the accompanying drawings in which:

FIG. 1 is a schematic cross section of a clamp showing the shear forces resulting from known methods of tensioning the compressive band around the clamping components;

FIG. 2 is a perspective view of an installation tool according to one aspect of the present invention in an opened condition prior to placing the clamping components onto a tubular member, and

FIG. 3 is a schematic plan view of the tool of FIG. 2 with the clamping components removed, and

FIG. 4 is a schematic plan view of the tool of FIG. 2 with the clamping components in place.

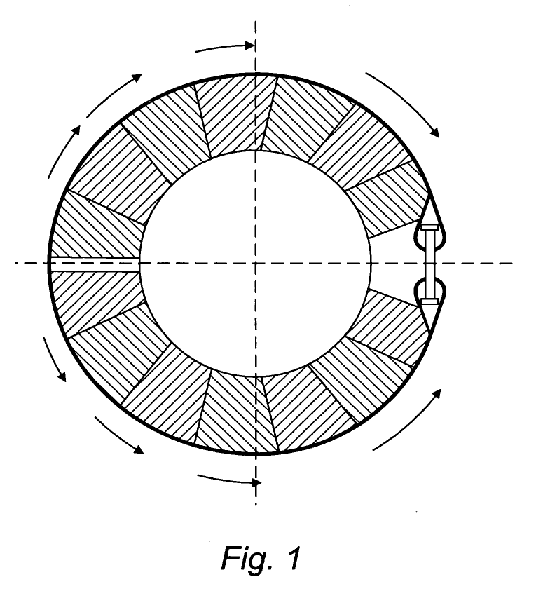

### DETAILED DESCRIPTION OF THE EMBODIMENTS

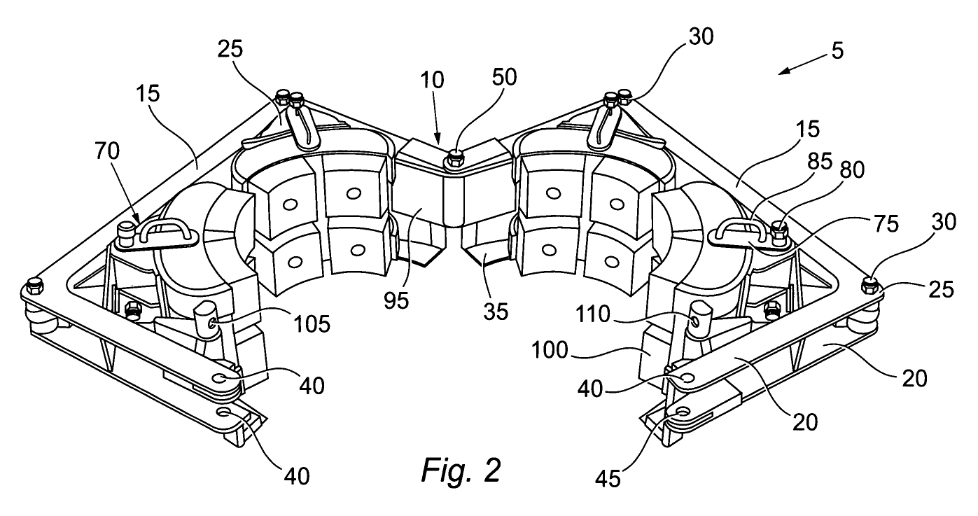

Turning now to FIG. 2 of the drawings, there is shown an installation tool 5 which comprises a frame 10 which in the preferred embodiment is formed of two substantially C-shaped frame elements 15. The frame may be formed from any suitable material such as aluminium, plastics, aluminium alloys, carbon steel or stainless steel, or reinforced composite materials. Aluminium and aluminium alloys plus composites offer simultaneous advantages of low weight and corrosion resistance. Where necessary such as if the frame or any components thereof are formed from a material which is corrosive in an off-shore environment, or operation of the frame is required sub-sea, the frame or the components may be coated with an anti-corrosive or other protective coating.

Each frame element is comprised of upper and lower frame members 20 which are secured together in the corners 25 via connectors such as bolts 30 which will be described further below. The lower frame members are provided with a flange 35 which extends substantially parallel to the lower frame member and extends into the centre of the frame.

The free ends 40 of the upper and lower frame members are provided with aligned apertures 45. A connector 50 which may be a further bolt passes through one set of the aligned apertures as shown in FIG. 2 in order to hingedly connect the two frame elements together.

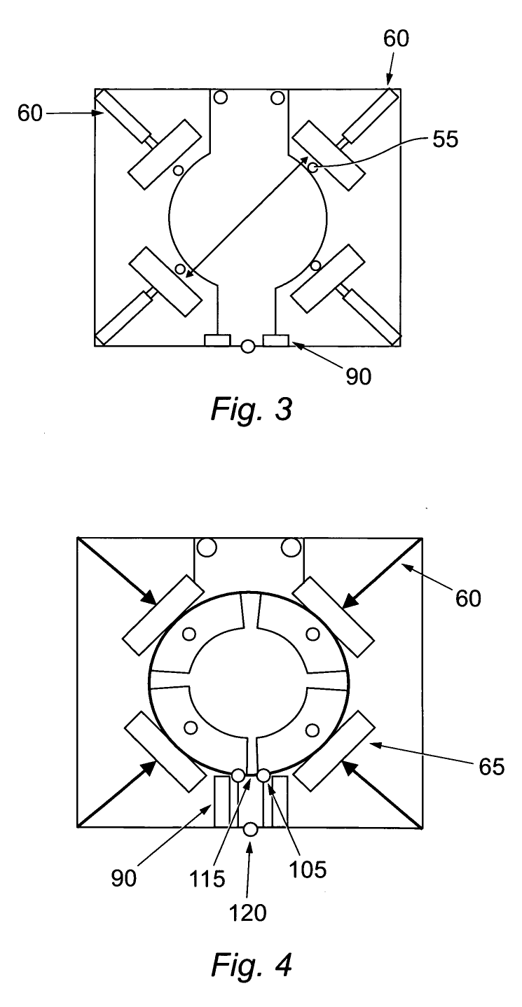

Mounting means are provided for securing a plurality of clamping components with the frame prior to installation upon a tubular member. The mounting means comprises a suction pad 55 provided on the flange 35 of the lower frame component. A suction pad is provided for each clamping component and therefore in the embodiment shown in FIGS. 2-4, four suction pads are provided. The suction pads are mounted on the flange diametrically opposite the corners 25 of the frame elements.

An actuator 60 which may preferably be a hydraulic actuator such as a hydraulic ram is mounted in each corner of the frame elements. One end of the hydraulic ram is secured to the frame elements 15. In the embodiment shown, the end of the hydraulic ram adjacent the frame element is bolted to the upper and lower frame members through bolt 30 such that the hydraulic rams extend diametrically from the corners 25 of the frame elements.

A reaction pad 65 is mounted on the free end of the hydraulic actuators 60. Securing means 70 are provided on the upper surface of the reaction pads for providing additional stability to the clamping components. The securing means comprises a bar 75 securable to the reaction pads via a bolt or screw 80. The upper surface of the bar has a handle 85 for ease of operation. In some embodiments of the invention, the securing means may replace the suction pads or in some embodiments may be dispensed with.

Reaction pads 90 may also be provided in the frame adjacent the opening of the frame elements, the function of which will be further described below.

In the embodiment shown, four clamp components are mounted in the frame at 80° and 100° respectively on each frame element rather than at 90° and 90° although other numbers of clamp components and other mounting positions are equally envisaged.

A method of installing a clamp on a riser using the installation tool described in FIG. 2 will now be described.

In the embodiment shown, four arcuate clamping components are mounted into the frame. The size of the clamp and therefore the clamping components is chosen to suit the outer diameter of the riser to which the clamp is to be fitted. Each clamping component has an internal concave surface which is provided with a resilient member which is preferably rubber.

Each clamping component is mounted onto a suction pad 55 on the flange 35 of the lower frame member 20. In embodiments in which a further securing means is provided, the bar 75 of the securing means is attached to the upper surface of the reaction pad 65 mounted on each hydraulic actuator 60. The bar extends over the upper surface of the clamping component and is tightened into position on top of the clamping component.

A compression band 95 preferably formed of a resilient material such as titanium or aramid fibres such as Kevlar® or Twaron® is mounted around the clamp components, the band being retained in a groove in the exterior surface of the components.

A loop 100 is provided at each end of the band and a rod 105 passes vertically through each end loop. Each rod has upper and lower aligned apertures 110 to receive a bolt 115 to connect the two ends of the band together. Reaction pads 90 are mounted adjacent the free ends 40 of the frame elements to provide assist in the tightening operation of the bolts through the bars.

The frame 5 of the installation tool is hinged open to allow the clamping components to be mounted within the frame. Each component is secured to the mounting means with the inner concave surface facing towards the centre of the frame.

The frame is then hinged closed around the riser at the appropriate height where it is intended to mount the clamp. Closing of the frame brings the two ends of the compression band 95 towards each other. A bolt, pin, latch or other securing means 120 is then inserted through the apertures in the free ends of the frame to hold the frame securely in position on the riser.

The hydraulic actuators 60 are then actuated to simultaneously push the clamping components forwards against the outer surface of the riser. The radial force that is applied by the actuators is slightly higher than required for clamping purposes and this load is then held until the one or more tightening bolts 115 of the compression band is fitted to connect the two ends of the band together. The band is then tensioned by rotation of the tightening bolt against the reaction pads 90 either by hand or using a torque tool on a minimal torque setting.

The hydraulic actuators are then withdrawn to release the clamping components as the actuators withdraw.

The clamping components are then disengaged from the retaining means and bolt 120 connecting the free ends of the frame elements together is removed such that the frame 10 can be hinged opened and released from the riser leaving the tensioned clamp in position around the riser.

By releasing the radial load on the components after final tightening of the compression band 95, this allows the compression band to be more evenly tensioned in an efficient manner. Consequently the clamping force is more evenly distributed and of a more reliable magnitude than is otherwise the case.

It will be readily appreciated that the installation tool and the method of installing a clamp using the tool as described allows a balanced uniform load to be radially applied to all clamping components simultaneously.

The radial load which can be applied to the resilient inner surface of the clamping components is significantly greater than is possible with known installation methods due to the high shear stresses which are created upon tightening of the compression bands using standard techniques. This is particularly important as the current trends in insulated, flexible flowlines call for clamps that can accommodate substantial radial contraction of the riser whilst maintaining clamping performance without unacceptable stressing of the flowline and clamping components. One embodiment of the present invention provides a clamp which can withstand a 5% radial strain such as a 16 mm diameter change on an 320 mm outer diameter riser. Further embodiments may be provided to withstand up to 10% radial change in the diameter of a riser.

Whilst the installation tool of the present invention has been described in relation to a 4 piece clamp, it is envisaged that other numbers of clamp components may be used. It is however preferable that an even number of clamping elements are provided although this is not essential.

The clamping components should be similar and symmetrical with respect to a pair of mutually perpendicular axes for balanced loading. However radial symmetry is not essential.

Additionally, whilst two symmetrical frame members have been described in the embodiment above, the frame may be formed of some other number of frame members for example 3 frame members may be preferable with two hinges where 3, 5 or 6 clamping components are used.

Furthermore, whilst the main embodiment has hydraulic rams applying the radial load to the clamp components, other actuators may be substituted such as pneumatic or mechanical actuators.

In the main embodiment the actuators are described as applying a force to the clamp components simultaneously. It is also envisaged that the actuators may be operated to apply a force to the clamp components sequentially.

In a further embodiment, the clamp components may be loaded into the frame in a closed position such as by dropping the components into place from above.

Whilst the routine use of the present invention will be on a reel-ship, lay-barge/semi-sub, lay-ship or floating platform, it is envisaged that the installation tool may be operated subsea. The installation too may be operated either manually, for example by divers who can adjust the position of the frame upon the riser, actuate the radial load means, tension the compression belt and remove the frame. Alternatively, the installation tool may be adapted for automated operation for example via an ROV or via a power cable operated from the surface.

The band described above may be replaced by a Titanium strap with axis bars mounted on either end, for example via a welding operation. The ends of the strap are brought together and bolts passed through apertures in the bars to tension the strap.

It will be readily apparent that a particular size of frame will be able to hold a range of sizes of clamp components and therefore it will be possible to mount several differently sized clamps onto differently sized risers using the same frame. This makes the installation tool a commercially attractive product. Furthermore, when not in use, the frame is easily stored and equally easily portable from one location to another.

The present invention is described as being suitable for locating buoyancy modules on risers but it should be appreciated that the tool could equally be used in other applications where it is necessary to mount a clamp upon a tubular element and pre-loading of the clamp before securing a compression band would give the same advantages as described above.

1. A method of installing a clamp on a tubular member, the method comprising the steps of placing the clamp around the tubular member, applying a radial load to the clamp and subsequently securing the loaded clamp to the tubular member.

2. A method according to claim 1, wherein the clamp comprises a plurality of clamping components and the method includes the step of applying a radial load to each clamping component simultaneously.

3. A method according to claim 1, wherein the radial load is uniformly applied around the clamp.

4. A method according to claim 1, wherein the clamping components are secured in position by a compression band which is tightened around the components.

5. A method according to claim 1, wherein the clamping components are mounted in a frame to be positioned around the tubular element to ensure correct positioning thereof.

6. A method according to claim 1, wherein the radial force is applied to the clamping components via a hydraulic actuator.

7. A method according to claim 6, wherein the radial force is applied to the clamping components via a hydraulic ram.

8. A tool for installing a clamp onto a tubular member, said tool comprising means for applying a radial load to the clamp before said clamp is secured to the tubular member.

9. A tool according to claim 8, wherein the clamp comprises a plurality of clamping components and the means for applying a radial load is adapted to apply the load to each clamp component simultaneously.

10. A tool according to claim 8, wherein the means for applying a radial load is adapted to apply the load uniformly around the clamp.

11. A tool according to any of claims 8, wherein the means for applying a radial load to the clamp members is a hydraulic actuator.

12. A tool according to claim 11, wherein the hydraulic actuator is a hydraulic ram.

13. A tool according to claim 12, wherein a separate hydraulic ram is provided for each clamp component.

14. A tool according to claim 9, wherein the tool further comprises a frame upon which the radial load means are carried.

15. A tool according to claim 14, wherein the frame comprises means for securing each clamping component prior to application to a tubular member.

16. A tool according to claim 14, wherein the frame comprises two frame members hinged together to allow the frame to be placed around a tubular member.
